(19) United States
(12) Patent Application Publication
(10) Pub. No.: US 2008/0210268 A1
(43) Pub. Date: Sep. 4, 2008

(54) Shopping Cart Washer and Sanitizer

(76) Inventors: James R. Metheny, Jefferson, GA (US); Ernest E. Decker, Jefferson, GA (US)

Correspondence Address: SHOEMAKER AND MATTARE, LTD, 10 POST OFFICE ROAD - SUITE 110, SILVER SPRING, MD, 20910, US

(21) Appl. No.: 12/031,563

(22) Filed: Feb. 14, 2008

Related U.S. Application Data
(60) Provisional application No. 60/889,841, filed on Feb. 14, 2007.
(60) Provisional application No. 60/909,204, filed on Mar. 30, 2007.

(51) Int. Cl. B08B 3/02

(52) U.S. Cl. 134/95.2

(57) ABSTRACT

A shopping cart washer and sanitizer includes an enclosure fitted with components that facilitate the entry and exit of rolling shopping carts. Within the apparatus, the carts are washed, rinsed, disinfected and dried. The apparatus is primarily for use inside retail establishments and is intended to provide each shopper a clean and sanitary shopping cart. A shopping basket washer is also disclosed.

This application claims benefit of provisional patent applications 60/889841, filed Feb. 14, 2007, and 60/909204, filed Mar. 30, 2007, the disclosures of which are incorporated herein by reference.

### BACKGROUND OF THE INVENTION

This invention relates to a shopping cart washer and sanitizer, more particularly to a self-contained high pressure cleaning unit for shopping carts, hand-held shopping baskets and the like.

Retail businesses, including grocery, clothing, auto parts, hardware and specialty stores, routinely provide to the shopper metal shopping carts, plastic hand held shopping baskets, canvas on metal frame shopping carts, plastic shopping carts or similar devices for transporting selected goods to a central checkout location. The carts are inevitably contaminated not only by the touch of users, but also from children, infants and pets who, if placed in the device may leave unsanitary bodily fluids and dirt on the device.

In the retail grocery, retail hardware trade and retail automotive product trade, cart contamination can also result from raw meats, raw fish, raw chicken, vegetables, chemicals (cleaners, paint products, dry masonry products, grease, oil and more), poisons (varmint control products, vegetation control products, insecticides, fertilizers, potting soils and more).

It is important to minimize or eliminate the potential for spread of germs and bacteria caused by using these devices, and it is equally important to eliminate the hazards introduced by human touch and those resulting from transporting chemicals and poisons with the shopping device.

By eliminating as much contamination as possible, not only are health risks reduced; potential legal claims on the retailer are also diminished, reducing the risk of direct losses, loss of productivity in defending claims and the direct expense of defending such claims.

Conventional practice is for the retailer occasionally to clean the shopping device outside the store with a pressure washer or similar mobile cleaning service. However, a better solution and more practical approach to preventing the spread of contaminants, bacteria and germs is not occasional cleaning but continual or frequent cleaning and disinfecting as the shopping device rotates through daily use.

Prior cart cleaning devices attempt to improve on the manual method of cleaning by introducing automation and germicide. However, they fall short of addressing the need for cleaning and disinfecting the shopping devices on an “each time use” (continual cleaning and disinfectant as the shopping device rotates through daily use by the consumer). Without a pattern of continual cleaning, even if a germicide is applied directly to the cart, the source of contamination will remain on the cart, thereby reducing the effectiveness of the germicide being applied.

Prior attempts to automate shopping cart cleaning have failed to provide easy access to automated units without the use of moving platforms, and have presented a hazard of limb injury to users and curious children. Such systems have also lacked control systems for making the wash, rinse and drying cycles fully automatic.

Continual cleaning of shopping carts decreases required maintenance by the accumulation of grit, dirt, and foreign particles on the carts' handles and in moving parts (i.e., wheels, bearings, hinges, etc.), reducing costs in repairs and down time to the retailer.

### SUMMARY OF THE INVENTION

An object of the invention is to provide a totally self-contained pressurized cleaning system for grocery carts, hand held shopping baskets and the like, which is easy to operate, is quiet and provides for the continual cleaning of carts as opposed to an occasional wash.

Another object is to improve the safety of automatic cart washing machines.

These and other objects are accomplished by the apparatus described below.

The apparatus of this invention includes an enclosure which defines a tunnel affixed to a frame. The unit may be hard wired and/or hard plumbed during new or remodeled store construction. Preferably, however, it has an electrical cord and plug so that it can be moved about, and a holding tank for retaining used washing liquids—if there is no plumbed drain—until they can be disposed of safely.

The apparatus is particularly designed to work with shopping carts or baskets having coded elements, such as RFID tags or chips, attached to or built into them. The apparatus includes an RFID proximity sensor, which activates the system when a cart having the coded element approaches. As the cart nears, the proximity sensor causes an electronic controller to open a closure at the tunnel entrance, admit the cart, and begin the wash cycle. The controller produces a sequence of wash, rinse, germicide application and dry phases. After the cart has exited the tunnel, the controller ends the cycle.

During the washing cycle, liquids are delivered under pressure from a motorized pump through control valves to an array of nozzles inside the unit. The wash liquids preferably are detergent solution, followed by rinse water, followed by a germicidal sanitizing solution.

The apparatus exterior may be adapted to provide advertising space and to display the retailer's logo. By promoting its clean and safe carts, the retailer receives additional value, while the consumer gets peace of mind and a more pleasant shopping environment. Advertising signs such as LED displays may also be placed on the top of the unit enabling the retailer to advertise “clean carts” and other information such as commercial advertising.

The invention is intended and expected to enhance the retail customers' level of satisfaction with the shopping experience and provide peace of mind as to their safety and that of their family and friends.

Having a self-contained cart washing unit inside the store eliminates the need to move large numbers of shopping carts at one time to an outside location to be cleaned, thus reducing labor costs.

### BRIEF DESCRIPTION OF THE DRAWINGS

In the accompanying drawings:

FIG. 1 is a top plan view of a cart washing apparatus embodying the invention;

FIG. 2 is a front elevation thereof;

FIG. 3 is a perspective view of the apparatus, with parts removed to show the interior;

FIG. 4 is a close-up of the inset “4” in FIG. 3;

FIG. 5 is a perspective view of the apparatus from the rear, with access panels removed; and

FIG. 6 is a rear elevation thereof.

### DESCRIPTION OF THE PREFERRED EMBODIMENT

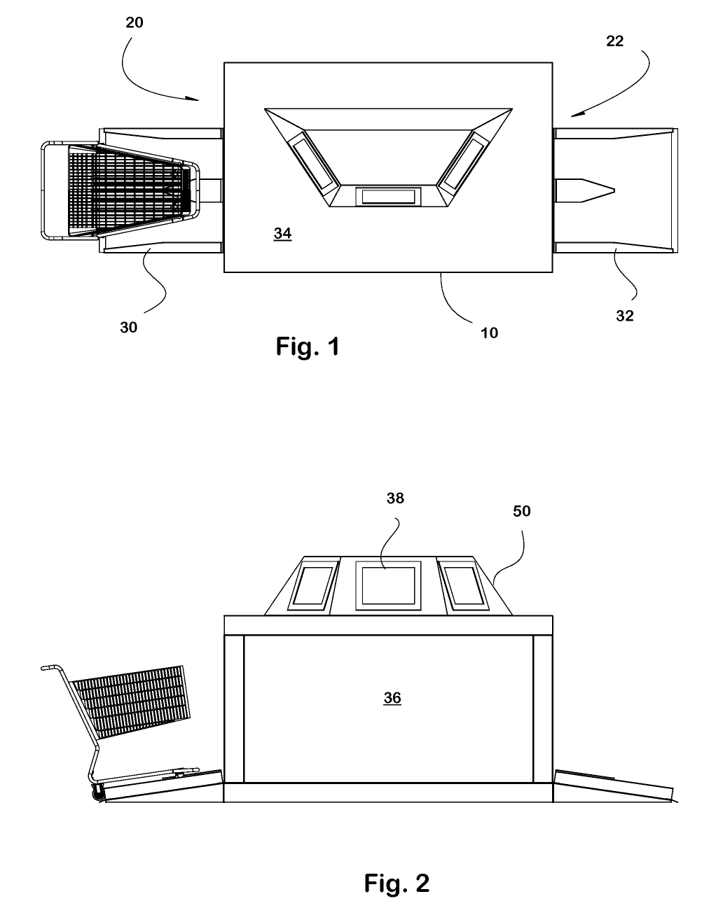

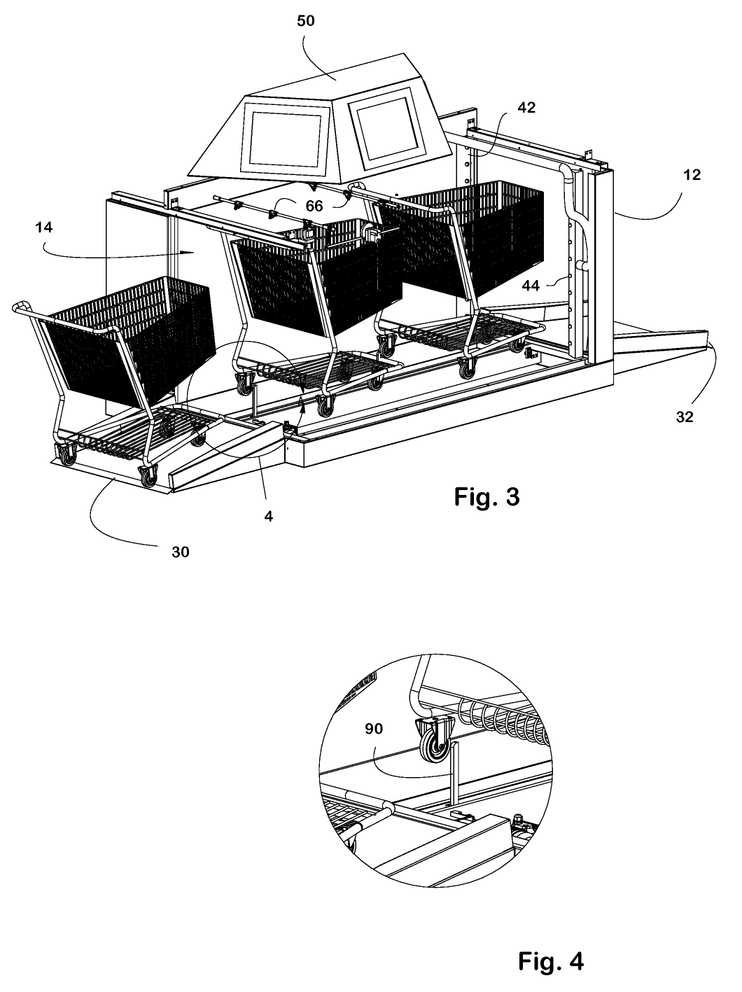

As shown in FIGS. 1 and 2, an apparatus embodying the invention includes an enclosure 10 supported on a frame 12 (FIG. 3) constructed by welding lengths of metal channel stock to form a sturdy support for the enclosure. Locking non-marring wheels (not shown) may be mounted at the corners of the underside of the enclosure to make it easier to move.

The enclosure 10 defines a tunnel 14 having side walls, a floor and a top, all of which are made of sheet metal and are attached to the frame using rustproof (e.g., stainless steel or aluminum) fasteners of appropriate size and length. The ends of the tunnel are open and define an entrance 20 and an exit 22 (FIG. 1).

The interior top, walls, and floor of the apparatus are made of materials that inhibit rust formation or are rustproof. Joints between the panels are sealed so as not to leak liquids to the outside. The walls, top and floor of the tunnel are preferably coated or covered with a sound limiting material of thickness sufficient to limit the noise emitted by the operation of the unit to a comfortable level

Entry and exit ramps 30, 32 are pivotally attached to the lower portion of the enclosure at the ends of the tunnel. The ramps can be folded upward to save space and close the ends of the tunnel when the apparatus is not in use. The top surfaces of the entry and exit ramps are covered with a waterproof and skid resistant material.

The top and front exterior surfaces 34, 36 of the enclosure are constructed of a durable material and provide space for advertising in the form of chloroplast (or similar material) signage display and/or electrical message signs 38.

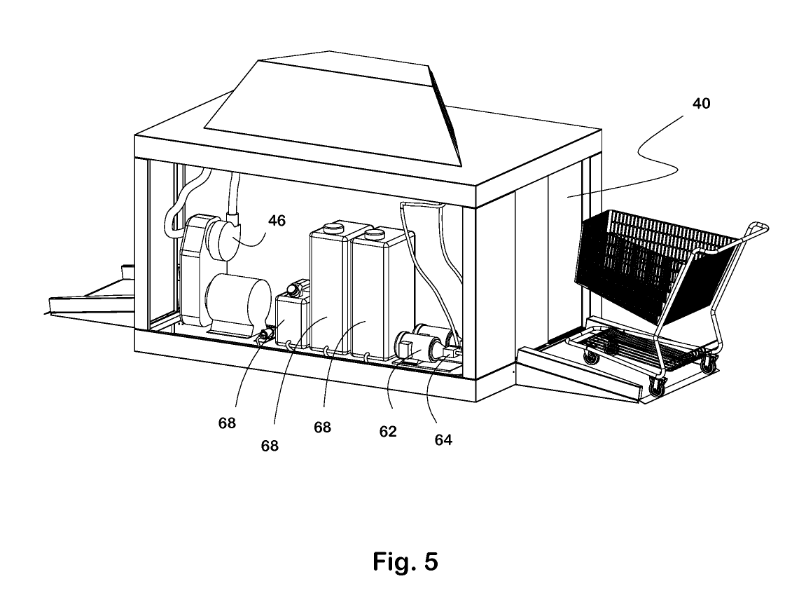

Tunnel closures such as horizontally sliding, segmented doors 40 at each end of the tunnel (one door being visible in FIG. 5) are provided to prevent objects other than shopping carts from getting into the apparatus. The doors, which are normally closed, also minimize the escape of mist and overspray from the tunnel. When either door is closed, its segments overlap at the side of the tunnel toward the rear of the enclosure. Each door has an operating mechanism (not shown) comprising an electric motor, or an electrically controlled fluid motor. The selection of the door operating mechanisms is a matter of design choice for a person of ordinary skill in this field.

The entrance door is opened automatically as a cart approaches the door by an electronic controller (98, described below) which drives the door motor and is responsive to a proximity sensor mounted on the apparatus. Preferably, the carts are provided with RFID coded tags and the proximity sensor (100, described below) which provides a triggering signal only when a properly coded tag comes within a prescribed distance. One purpose of this is to prevent children from opening the doors. Also, each door operating mechanism preferably includes a sensing circuit which generates an alarm signal when someone attempts to force the doors open manually. The alarm signal may be used to shut down the washing apparatus in this event.

A blower 46 inside the enclosure (see FIG. 5) draws ambient air from outside the enclosure through a filter. At the exit end 22 of the tunnel, there are two perforated air ducts 42, 44 (FIG. 3), one on either side of the exit, which are fed by the blower. Each duct extends from the floor to the top of the exit opening and has apertures through which air escapes in a direction toward the passing carts to dry them. Preferably, the ducts are oriented so that air flow is directed at an angle back into the tunnel to retain overspray and mist.

FIG. 3 also shows, on the top of the apparatus, a hood 50 which may contain display panels 38 for the store's or advertisements. Preferably, the display panels are video displays, in which case electronics required to drive the displays may be mounted inside the hood.

The apparatus contains a washing unit which comprises (FIG. 5) a pump 62, at least one multi-way valve 64, and an array of spray nozzles 66 (FIG. 3). The spray nozzles are sufficient in number and type to direct cleaning liquid under pressure at all parts of passing carts in the tunnel. The cleaning liquid (i.e., water, optionally containing detergent or other cleansers) is fed by a pump to the spray nozzles via supply lines from onboard liquid supply tanks 68, 69, 70. The liquid is routed via the multi-way valve 64 to the pump and nozzles. The pump 62 is powered by a motor selected so as to provide adequate pressure and volume to the spray nozzles.

Optionally, the washing unit may include an “on demand” inline water heater (not shown) to provide hot liquids for improved effectiveness in the cleaning process.

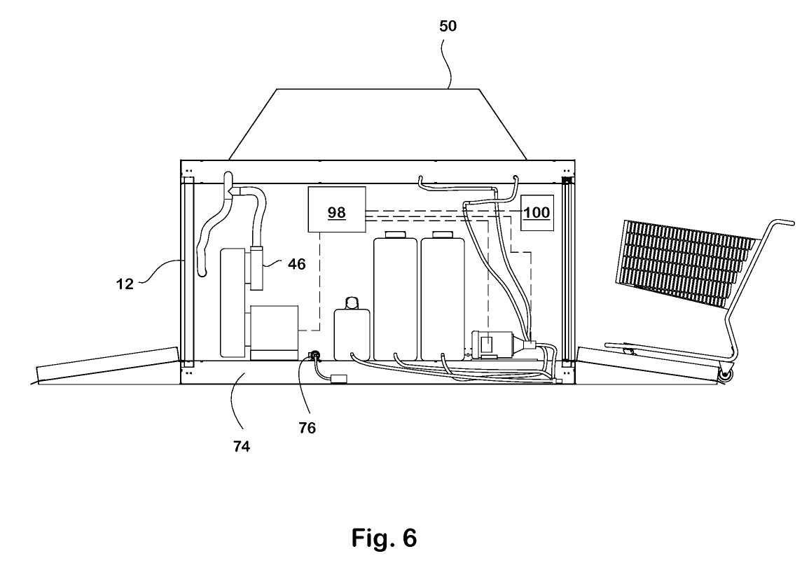

A drain in the tunnel floor (but not visible in FIG. 3) allows used liquids which collect on the floor of the tunnel to enter the holding tank 74 (FIG. 6) situated beneath the floor for safe disposal. The holding tank is located under the enclosure, and includes a sump pump 76 which can be activated to empty the holding tank.

The carts are guided through the tunnel by tension rails (not shown) mounted on the sides of the interior on the tunnel.

FIG. 3 shows a portion of the cart conveyor within the apparatus. It comprises an endless loop of link chain or the like, with paddles 90 (FIG. 4) attached at intervals. The paddle size preferably can be adjusted to accommodate different sizes and styles of shopping carts. The loop moves along a path define by a series of roller bearings (i.e., pillow blocks with bearing inserts with a shaft) which support the loop. The loop is driven by an electric motor affixed to the back side of the enclosure inside an enclosed mechanical compartment. As the loop rotates, an upwardly projecting paddle contacts the bottom of the shopping cart and pulls it into the tunnel. Preferably, the conveyor is caused to dwell for a period of time while the cart is inside the tunnel, so that the washing unit can go through its cycle.

The electronic controller 98 shown schematically in FIG. 6 operates the doors, the washing unit and the blower. The controller regulates the cleaning cycles, determines the conveyor speed and dwell, and delivers cleaning agents at scheduled times or cart positions during the cleaning process. The controller is connected to a proximity sensor 100 which produces a triggering signal when a cart approaches the tunnel. Triggered by the sensor 100, the controller opens the entrance door, activates the conveyor, closes the door, operates the pump and the valving synchronization to wash, rinse and sanitize the cart, then opens the exit door, restarts the conveyor and activates the blower to dry the cart as the cart is ejected. Many suitable controllers and proximity sensors are well known and commercially available. Inasmuch as their selection and programming are matters of ordinary skill, they are not described in detail.

While the invention has been described as for shopping carts, and the drawings illustrate only wheeled carts, it should be understood that the invention may be readily adapted to washing other shopping containers such as plastic or wire baskets.

Since the invention is subject to modifications and variations, it is intended that the foregoing description and the accompanying drawings shall be interpreted as only illustrative of the invention defined by the following claims.

We claim:

1. An apparatus for cleaning shopping carts and baskets, said apparatus comprising
an enclosure defining a wash tunnel having an entrance and an exit,
means for moving shopping carts through said tunnel,
a washing unit within said enclosure, for directing washing liquid at the shopping carts moving through said tunnel, and
means for drying said carts.

2. The invention of claim 1, further comprising closures at the entrance and at the exit of the tunnel, for minimizing escape of water from the tunnel, while allowing carts to pass therethrough.

3. The invention of claim 2, wherein the closures are horizontally sliding doors operated by respective motors.

4. The invention of claim 3, wherein each door comprises plural telescoping segments which overlap when the door is open.

5. The invention of claim 1, wherein the washing unit comprises
an array of wash nozzles for directing water at carts passing through said tunnel, a water supply tank,
a pump in said water supply line for drawing water from said supply tank and for delivering at high pressure to said nozzles,
a water heater disposed in said water supply line for heating water en route to said nozzles,
a hydraulic control system for regulating the flow of water from the water supply tank to the nozzles, and
means for synchronizing operation of said moving means and said hydraulic control system.

6. The invention of claim 1, further comprising a fitting for connecting water supply tank to a public water supply.

7. The invention of claim 1, wherein the drying means comprises a blower, a plurality of vents downstream of the blower adjacent the tunnel exit for directing air at said carts as they exit the tunnel, an air filter upstream of the blower for removing contaminants from ambient air.

8. The invention of claim 1, wherein said vents are directed back into the unit to minimize the escape of overspray and mist remaining airborne as the final cycle ends;

9. The invention of claim 1, further comprising
an electronic controller to regulate both the movement of the carts through the apparatus and the delivery of cleaner, rinse water and disinfectant at appropriate time during the cleaning process; and
valves operated by the controller to control the delivery and flow of appropriate liquid to the spray nozzles.

10. The invention of claim 1, further comprising hinged entry and exit ramps for aiding movement of carts into and out of the apparatus.

11. The invention of claim 1, wherein the synchronizing means comprises a proximity sensor adapted to detect a shopping cart approaching the apparatus, and means responsive to said sensor for automatically starting and stopping wash, rinse and disinfectant cycles.

12. The invention ov claim 11, wherein the proximity sensor is adapted to respond only to a coded element on the shopping cart.

13. The invention of claim 12, wherein the coded element is an RFID tag or chip.

13. The invention of claim 1, further comprising a holding tank for receiving and containing used washing liquid, and fittings for connecting the holding tank to a sewer.
